(19) United States
(12) Patent Application Publication
(10) Pub. No.: US 2017/0144403 A1
(43) Pub. Date: May 25, 2017

(54) SLIP-RESISTANT PROTECTIVE MAT

(71) Applicant: Dimex Office Products LLC, Marietta, OH (US)

(72) Inventors: Kevin Morey, Marietta, OH (US); Forrest Adam Sanders, Marietta, OH (US); Will Stottsberry, Caldwell, OH (US); David T. Wesel, Marietta, OH (US)

(73) Assignee: Dimex Office Products LLC, Marietta, OH (US)

(21) Appl. No.: 15/299,538

(22) Filed: Oct. 21, 2016

Related U.S. Application Data
(60) Provisional application No. 62/330,298, filed on May 2, 2016.
(60) Provisional application No. 62/259,125, filed on Nov. 24, 2015.

(51) Int. Cl. B32B 3/06; B32B 27/30; B32B 7/14; B32B 27/08; B32B 3/08; B32B 3/30

(52) U.S. Cl. CPC B32B 3/06; B32B 3/085; B32B 3/30; B32B 7/14; B32B 27/08; B32B 27/304; B32B 2250/02; B32B 2250/246; B32B 2255/10; B32B 2307/536; B32B 2471/04

(57) ABSTRACT

A slip-resistant protective mat is configured to reduce slippage with an underlying surface. The slip-resistant protective mat includes a body layer having opposing upper and lower surfaces, and a plurality of slip-resistant pads having upper and lower surfaces. The upper surface of the plurality of slip-resistant pads is attachable to the lower surface of the body layer. The lower surface of the plurality of slip-resistant pads includes a plurality of deformable hooks of a hook-and-loop type connector configured to attach to an underlying carpeted surface. Alternatively, or in addition to the slip-resistant pads containing deformable hooks, the lower surface of one or more of the plurality of slip-resistant pads may include a high-polished, smooth finish with a Shore hardness of between about 55 A to about 70 A configured to obtain maximum surface contact and to reduce slippage with an underlying hard surface.

### CROSS REFERENCE TO RELATED APPLICATION

This application claims the priority of U.S. Provisional Patent Application Ser. No. 62/330,298, filed on May 2, 2016 and U.S. Provisional Patent Application Ser. No. 62/259,125, filed on Nov. 24, 2015, the entire disclosures of which are hereby incorporated by reference herein.

### TECHNICAL FIELD

This invention generally relates to protective mats and, more particularly, to slip-resistant protective mats and methods of manufacturing slip-resistant protective mats for use on a variety of underlying surfaces.

### BACKGROUND OF THE INVENTION

Mats used to protect flooring surfaces and other surfaces from damage and wear are well known. Generally, these protective flooring mats fall into two categories: mats used to protect textured flooring surfaces (such as carpet) and mats used to protect hard flooring surfaces (such as hardwood or tile). For protective mats used to protect textured flooring surfaces, rigid studs or rigid spikes located on the bottom of the protective mat interact with the carpet pile to hold the protective mat in place. The length of these rigid studs or rigid spikes varies according to the height of the carpet pile. While protective mats with rigid studs or rigid spikes generally prevent the protective mat from sliding or moving and improve the placement of a protective mat on textured flooring surfaces, such protective mats are unsuitable for hard flooring surfaces. In addition, in order for the rigid spikes to be effective, they need to be long and pointed and therefore can be a hazard when transporting the protective mat. Instead, protective mats with a non-studded or non-spiked bottom surface are used for hard flooring surfaces. This forces mat manufacturers to produce a first mat for hard flooring surfaces and a second mat for textured flooring surfaces. It would be of immense value for mat manufacturers to provide a single protective mat that serves both hard surfaces and textured surfaces, so that the retailer only needs to carry a single mat to address both situations.

Some attempts to provide a protective mat that is suitable for both textured surfaces and hard surfaces have been made. For example, some protective mats use a felt backing and recessed rigid studs to accommodate both a textured flooring surface and a hard flooring surface. However, the felt backing and recessed rigid studs do not suitably prevent the protective mat from slipping on textured surfaces, such as carpet.

Other attempts have applied a non-slip coating to the bottom surface of the protective mat, potentially using a mechanical spray application or a roller transfer system. However, these applied coatings may leave behind an undesirable residue on the underlying surface when removed. Even if a residue is not left behind, a user's perception that a residue may be left behind or that the coating may wear away is also undesirable. Further, these coatings may contain an adhesive to better secure the protective mat to the surface. The use of adhesive coatings, while beneficial to prevent slippage, may result in dust and dirt accumulating on the bottom surface of the protective mat, which may diminish the slip-resistant characteristics of the adhesive coating over time and/or be visually unappealing. This may force a user to either clean or discard the protective mat. Not only do these options risk leaving residue behind and collecting debris, neither of them work all that well on carpet.

Accordingly, there is a need for a cost-efficient and visually appealing slip-resistant protective mat used to cover a variety of underlying surfaces regardless of the underlying surface's material and texture that would provide retailers and/or customers a single slip-resistant protective mat solution that could be used for either underlying textured surfaces or underlying hard surfaces.

### SUMMARY OF THE INVENTION

In accordance with various embodiments, a slip-resistant protective mat is configured to reduce slippage with an underlying surface. The slip-resistant protective mat includes a body layer having opposing upper and lower surfaces, and a plurality of slip-resistant pads having opposing upper and lower surfaces. The upper surface of the plurality of slip-resistant pads is attachable to the lower surface of the body layer. The lower surface of the plurality of slip-resistant pads includes a plurality of deformable hooks of a hook-and-loop type connector configured to attach to an underlying carpeted surface, and/or a high-polished, smooth finish with a Shore hardness of between about 55 A to about 70 A configured to obtain maximum surface contact and to reduce slippage with an underlying hard surface.

In some embodiments, the lower surface of the body layer includes a plurality of recessed portions sized to accommodate the plurality of slip-resistant pads. In other embodiments, the body layer is integrally formed as a unitary piece with the plurality of slip-resistant pads.

In some embodiments, each hook of the plurality of deformable hooks includes a single projection configured to attach to an underlying carpeted surface to reduce slippage. In other embodiments, each hook of the plurality of deformable hooks includes first and second oppositely facing projections configured to attach to an underlying carpeted surface to reduce slippage in first and second lateral directions.

In some embodiments, the upper and lower surfaces of the plurality of slip-resistant pads have a transparent and high-polished, smooth finish obtained using a chromed rolling process.

In some embodiments, the body layer has a thickness of between about 0.06 inches to about 0.20 inches, and the plurality of slip-resistant pads have a thickness of between about 0.03 inches to about 0.04 inches.

In some embodiments, the plurality of slip-resistant pads are attached to the lower surface of the body layer using an adhesive. Yet in other embodiments, the plurality of slip-resistant pads are attached during the manufacture of the slip-resistant protective mat using a lamination process with or without the use of an adhesive.

In some embodiments, at least one of the plurality of slip-resistant pads is circular in shape and has a diameter of between about 1.5 inches to about 2 inches, is shaped as a rectangular strip, and/or is shaped so as to parallel a corner of the body layer.

In some embodiments, at least one of the plurality of slip-resistant pads has an increased size and is positioned near the center of the slip-resistant protective mat, and may optionally include a graphic image on the upper surface of at least one of the plurality of slip-resistant pads that is viewable through the body layer.

In some embodiments, the upper surface of the body layer has a textured finish obtained during the manufacture of the slip-resistant protective mat using a textured rolling process.

In some embodiments, the slip-resistant protective mat is one of: a desk mat, a place mat, a chair mat, and a floor mat. For example, the body layer may be shaped to include an extension portion configured to be placed into a well area of a desk.

In accordance with yet another aspect of this invention, a slip-resistant protective mat is configured to reduce slippage with an underlying hard surface. The slip-resistant protective mat includes a body layer having opposing upper and lower surfaces, with the body layer being formed substantially from a first polyvinyl chloride material. The slip-resistant protective mat also includes a slip-resistant layer having opposing upper and lower surfaces. The lower surface of the slip-resistant layer has a high-polished, smooth finish configured for maximum surface contact to reduce slippage with the underlying hard surface. The slip-resistant layer is formed substantially from a second polyvinyl chloride material. The slip-resistant layer has a Shore hardness of between about 55 A to about 70 A configured to obtain maximum surface contact and to reduce slippage with the underlying hard surface.

In some embodiments, the slip-resistant protective mat is formed by laminating the lower surface of the body layer to the upper surface of the slip-resistant layer, the lamination being improved since the body layer and the slip-resistant layer are formed substantially from the respective first and second polyvinyl chloride materials.

In some embodiments, the upper and lower surfaces of the slip-resistant layer have a transparent and high-polished, smooth finish obtained using a chromed rolling process.

In some embodiments, the slip-resistant layer includes a plurality of discrete slip-resistant pads having upper and lower surfaces, the upper surface of the slip-resistant pads being attachable to the lower surface of the body layer. Yet in other embodiments, the body layer is coextensive with the slip-resistant layer.

Another aspect of this invention is a method of manufacturing a slip-resistant protective mat. The method includes obtaining a body layer having opposing upper and lower surfaces, with the body layer being formed substantially from a first polyvinyl chloride material. The method also includes obtaining a slip-resistant layer having opposing upper and lower surfaces. The lower surface of the slip-resistant layer has a high-polished, smooth finish configured for maximum surface contact to reduce slippage with the underlying surface. The slip-resistant layer is formed substantially from a second polyvinyl chloride material. The method also includes laminating the lower surface of the body layer to the upper surface of the slip-resistant layer to form the slip-resistant protective mat. The lamination is improved since the body layer and the slip-resistant layer are formed substantially from the respective first and second polyvinyl chloride materials.

In some embodiments, the slip-resistant layer includes a plurality of discrete slip-resistant pads having upper and lower surfaces, such that the laminating step further includes laminating the upper surface of the slip-resistant pads to the lower surface of the body layer, with or without the use of an adhesive.

In some embodiments, the laminating step occurs at a temperature of about 350 degrees Fahrenheit.

Additional details and advantages of slip-resistant protective mats and associated methods of manufacture will become more apparent upon review of the following detailed description taken in conjunction with the accompanying drawings.

### BRIEF DESCRIPTION OF THE DRAWINGS

The above-mentioned and other features and advantages of this invention, and the manner of attaining them, will become more apparent and the invention itself will be better understood by reference to the following description of embodiments of the invention taken in conjunction with the accompanying drawings, wherein:

FIG. 1 is a schematic top view of a first exemplary embodiment of a slip-resistant protective mat that includes a plurality of slip-resistant pads;

FIG. 2A is an enlarged cross-sectional view of the slip-resistant protective mat of FIG. 1 taken across line 2-2, where the slip-resistant pad includes deformable hooks and is attached to the lower surface of the body layer using an adhesive;

FIG. 2B is an enlarged cross-sectional view similar to FIG. 2A, where the slip-resistant pad includes deformable hooks and is attached to the lower surface of the recessed portion of the body layer using adhesive according to another exemplary embodiment;

FIG. 2C is an enlarged cross-sectional view similar to FIG. 2B, where the slip-resistant pad includes deformable hooks and is directly attached to the lower surface of the recessed portion of the body layer without the use of an adhesive according to another exemplary embodiment;

FIG. 2D is an enlarged cross-sectional view similar to FIG. 2C, where the slip-resistant pad includes discretely spaced pad portions that include deformable hooks, with the slip-resistant pad being directly attached to the lower surface of the recessed portion of the body layer without the use of an adhesive according to another exemplary embodiment;

FIG. 2E is an enlarged cross-sectional view similar to FIG. 2A, where the slip-resistant pad is integrally formed as a unitary piece with the body layer according to another exemplary embodiment;

FIG. 2F is an enlarged cross-sectional view similar to FIG. 2A, where the slip-resistant pad includes a highly-polished, smooth finish and is attached to the lower surface of the body layer using an adhesive according to another exemplary embodiment;

FIG. 3 is a schematic top view similar to FIG. 1, where the plurality of slip-resistant pads are shaped either as rectangular strips or a center circle having an increased size according to another exemplary embodiment;

FIG. 4 is a schematic top view similar to FIG. 3, where the plurality of slip-resistant pads are shaped so as to conforms to the shape of a corner of the body and as a center rectangle having an increased size according to another exemplary embodiment;

FIG. 5 is a schematic top view of a slip-resistant protective mat including a body layer that is coextensive with slip-resistant layer according to another exemplary embodiment; and

FIG. 6 is a cross-sectional view of the slip-resistant protective mat shown in FIG. 5 taken across line 5-5, where the body layer is attached without the use of an adhesive.

### DETAILED DESCRIPTION

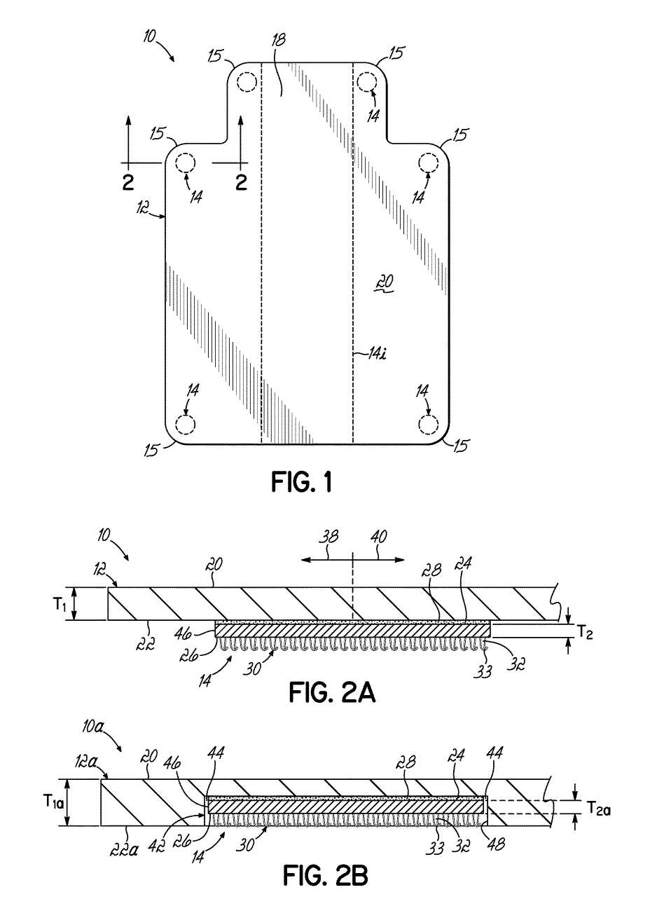

Referring now to the drawings, and to FIG. 1 in particular, a slip-resistant protective mat 10 according to a first exemplary embodiment of the invention is shown. The slip-resistant protective mat 10 includes a body layer 12 and a plurality of slip-resistant pads 14. The function, benefits, and structure of the various features are described in turn below in connection with the respective Figures, where similar reference numerals refer to similar features.

The slip-resistant protective mat 10, 10a, 10b, 10c, 10d, 10e, 10f, 10g, 10h according to the various exemplary embodiments is configured to reduce slippage with an underlying surface. Suitable underlying surfaces may include, for example, textured surfaces (such as carpet including commercial-grade, medium-pile, and high-pile variations) and hard surfaces (such as hardwood, laminate, and tile). For example, an underlying hard surface 16 is shown in FIG. 6. Suitable carpet types may include, for example, Berber, level loop, multi-level loop, random sheared, tip sheared, velvet/plush, twist, frieze, Saxony, shag and various other types of carpet. The slip-resistant protective mat 10, 10a, 10b, 10c, 10d, 10e, 10f, 10g according to the various exemplary embodiments, enables manufacturers and retailers to market, stock, and sell a single slip-resistant protective mat that may be used on hard and/or textured underlying surfaces. This offers a significant advantage over conventional mats, since the retailer needs to stock only one mat instead of two (one for textured surfaces and one for hard surfaces). While not shown, the slip-resistant protective mat 10, 10a, 10b, 10c, 10d, 10e, 10f, 10g, 10h may alternatively straddle two or more underlying surfaces (such as tile and carpet or hardwood and carpet). Straddling two or more underlying surfaces is also problematic with conventional mats, although the situation is less commonly experienced.

FIG. 1 shows a slip-resistant protective mat 10 for use as a chair mat which includes an extension portion 18 configured to be placed into a well area of a desk. While not shown, persons skilled in the art would appreciate that these principles also extend to other types of slip-resistant protective mats 10 such as, for example, desk mats, place mats, and floor mats (including floor runners). In one illustrative example, a desk mat or place mat may be used to protect the underlying surface of a wooden table. While the slip-resistant protective mat 10 lies smoothly against an underlying surface, the slip-resistant protective mat 10 may be rolled up for shipping or storage.

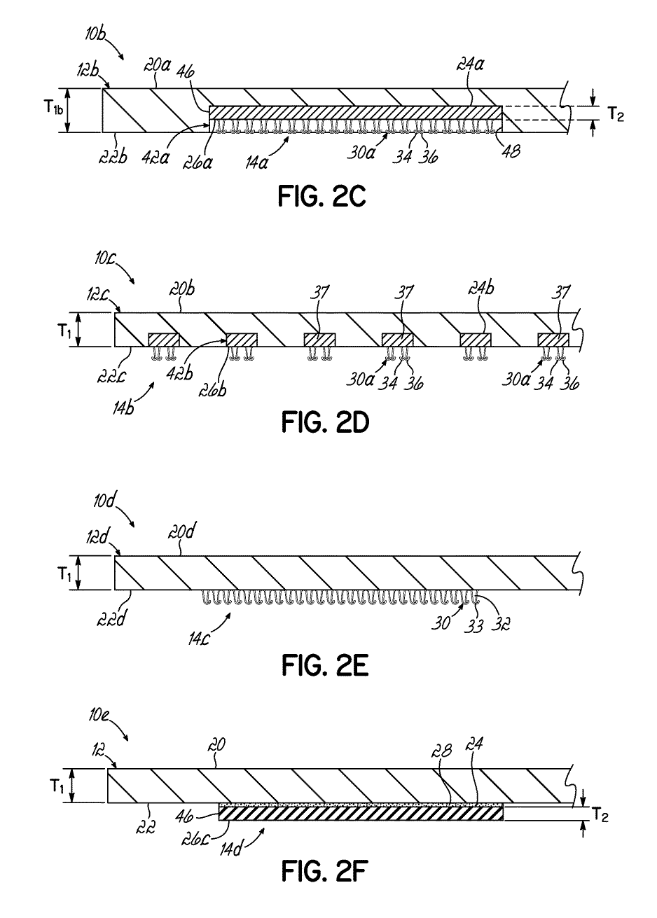

As shown in FIG. 1, the slip-resistant protective mat 10 includes six 2 inch diameter slip-resistant pads 14 designed for textured surfaces and a slip-resistant pad 14i designed for hard surfaces. As shown, each of the slip-resistant pads 14 is placed about 0.5 inches in from an external corner 15. The slip-resistant pad 14i, designed for hard surfaces, is shaped as a two foot wide strip of no-skid low durometer film down the middle of the chair mat starting at an extension portion 18 and extending all the way from edge to edge. However, persons skilled in the art would appreciate that the slip-resistant pad may have a variety of suitable shapes and sizes. The slip-resistant material of the slip-resistant pad 14i will be described below with reference to FIG. 2F that prevents slippage on hard underlying surfaces.

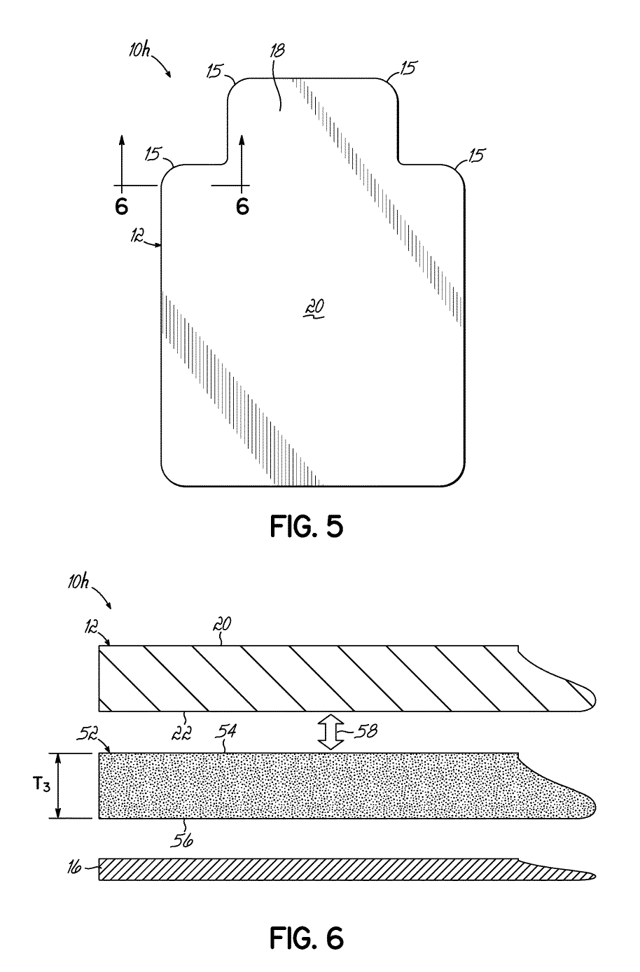

FIGS. 2A-2F show cross-sectional views of various exemplary embodiments of the slip-resistant protective mat 10, 10a, 10b, 10c, 10d, 10e which will be described below in accordance with the principles of this invention. Generally, the body layer 12, 12a, 12b, 12c, 12d has an upper surface 20, 20a, 20b that opposes a lower surface 22, 22a, 22b. According to one exemplary embodiment, the body layer 12, 12a, 12b, 12c may have a thickness T1, T1a of between about 0.06 inches to about 0.20 inches. However, persons skilled in the art would appreciate that other thicknesses may be suitably used. Typically, mats used to protect hard underlying surfaces may be as thin as about 0.06 inches since only a thin layer is necessary to protect the surface. Mats used to protect textured surfaces typically range from about 0.085 inches to about 0.20 inches, to provide adequate stiffness to prevent an object, such as desk chair casters, from causing depressions or dents in the mat. As will be discussed in greater detail in relation to FIGS. 5 and 6, the body layer 12, 12a, 12b, 12c according to the various embodiments may be made substantially from a first polyvinyl chloride material having a Shore hardness of between about 50 D to about 65 D. The Shore D Hardness Scale generally measures the hardness of hard rubbers, semi-rigid plastics, and hard plastics. In the context for a chair mat, this allows for the casters of an office chair to roll smoothly on the upper surface 20, 20a, 20b. The body layer 12, 12a, 12b, 12c may be made by a variety of manufacturing processes known to one skilled in the art. One such suitable manufacturing process is an extrusion-calendaring process. The upper surface 20, 20a, 20b may have a smooth surface obtained using a variety of manufacturing processes, or may have a textured finish obtained using a textured rolling process.

With continued reference to FIGS. 2A-2F, each slip-resistant pad 14, 14a, 14b, 14c has an upper surface 24, 24a, 24b, 24c that opposes a lower surface 26, 26a, 26b, and 26c. For example, the slip-resistant pads 14, 14a, 14b, 14c may have a thickness T2 (as shown in FIGS. 2A and 2F) of between about 0.03 inches to about 0.04 inches, when measuring the distance between the upper surface 24, 24a, 24b, 24c and the lower surface 26, 26a, 26b, 26c. The upper surface 24, 24a, 24b, 24c of the slip-resistant pad 14, 14a, 14b, 14c is attachable to the lower surface 22, 22a, 22b, 22c of the body layer 12, 12a, 12b, 12c using a variety of suitable attachment methods. It is desirable that the slip-resistant pad 14, 14a, 14b, 14c be attached to the body layer 12, 12a, 12b, 12c in a manner sufficient to prevent the slip-resistant pad 14, 14a, 14b, 14c from being inadvertently separated from the body layer 12, 12a, 12b, 12c, which may sustain high sheer loads in first and second lateral directions 38, 40 (shown in FIG. 2A).

With continued reference to FIGS. 2A-2D and 2F, the slip-resistant pads 14, 14a, 14b, 14d may be attached to the lower surface 22, 22a, 22b, 22c of the body layer 12, 12a, 12b, 12c at the same time or at different times. For example, some or all of the slip-resistant pads 14, 14a, 14b, and 14d may be attached to the lower surface 22, 22a, 22b, 22c of the body layer 12, 12a, 12b, 12c during the manufacture of the slip-resistant protective mat 10, 10a, 10b, 10c, 10e. Similarly, some or all of the slip-resistant pads 14, 14a, 14b, 14c may be attached to the lower surface 22, 22a, 22b, 22c of the body layer 12, 12a, 12b, 12c after the manufacture of the body layer 12, 12a, 12b, 12c, potentially by the manufacturer, wholesaler, retailer, installer or customer at a later time. Attaching the slip-resistant pads 14, 14a, 14b, 14d at a later time allows for customization depending on the application, such as the particular underlying surface or surfaces. In one illustrative example, one or more of the slip-resistant pads 14, 14a, 14b, 14d may be attached to the body layer 12, 12a, 12b, 12c by the customer, depending on the specific underlying surface or surfaces. One or more slip-resistant pads 14, 14a, 14b, 14d may be packaged together with the body layer 12, 12a, 12b, 12c as a “kit”, or alternatively, one or more slip-resistant pads 14, 14a, 14b, 14d may be sold separately from the body layer 12, 12a, 12b, 12c allowing the customer to customize the slip-resistant protective mat 10, 10a, 10b, 10c, 10e, as desired.

As shown in FIGS. 2A, 2B, and 2F, the slip-resistant pad 14, 14d may be attached to the lower surface 22, 22a of the body layer 12, 12a using an adhesive 28. The adhesive 28 may be disposed on the upper surface 24, 24c of the slip-resistant pad 14, 14d. The adhesive 28 may be exposed through removal of a disposable backing (not shown). Alternatively, the adhesive 28 may be disposed on the lower surface 22 of the body layer 12, 12a, whereby removing a disposable backing (also not shown) exposes the adhesive 28 when the body layer 12, 12a is ready for attachment with the slip-resistant pad 14, 14d. A variety of suitable adhesives 28 may be used, the selection of which may depend, at least in part, on the material of the body layer 12, 12a and/or the material of the slip-resistant pad 14, 14d. For example, in one exemplary embodiment adhesive style #72 or adhesive style #75, both commercially available from Velcro USA Inc. of Manchester, N.H. may be used. In another exemplary embodiment, Aroset™ 1084 or Aroset™ 1085, both commercially available from Ashland, Inc. of Covington, Ky.

As shown in FIGS. 2A-2E, the lower surface 26, 26a, 26b of the slip-resistant pad 14, 14a, 14b, 14c includes a plurality of deformable hooks 30, 30a of a hook-and-loop type connector (such as Velcro®) that may be configured to attach to an underlying carpeted surface (not shown). As shown in FIGS. 2A, 2B, and 2E, the deformable hooks 30 may each have a base 32 supporting a single projection 33. According to one exemplary embodiment, the deformable hooks may be low-profile hooks that suitably performs on a variety of underlying textured surfaces without causing the slip-resistant mat 10, 10a, 10b to be significantly raised from a hard surface, enabling the slip-resistant mat 10, 10a, 10b to perform well with both textured and hard underlying surfaces. Additionally, low-profile hooks allow the slip-resistant pads 14, 14a, 14b, 14c to be applied during manufacturing and still perform well on both textured and hard underlying surfaces.

Alternatively, as shown in FIGS. 2C and 2D, each of the deformable Hooks 30a may include a base 32 supporting first and second oppositely facing projections 34, 36 that may be configured to attach to an underlying carpeted surface to reduce slippage in the first and second lateral directions 38, 40 (shown in FIG. 2). The deformable hooks 30a shown in FIGS. 2C and 2D are known as high technology hook style #24, and are commercially available from Velcro USA Inc. of Manchester, N.H. While the deformable hooks 30 shown include 130 hooks per square inch with a hook height of 0.097 inches, persons skilled in the art would appreciate that various other shapes and sizes of deformable hooks 30 and bases 32 are also suitable. For example, in another exemplary embodiment, the deformable hooks 30a may be hook style #511, also commercially available from Velcro USA Inc. of Manchester, N.H.

The deformable hooks 30, 30a are configured to attach to the underlying carpet surface to prevent the slip-resistant protective mat 10, 10a, 10b, 10c from migrating with respect to the underlying carpet surface (not shown). For example, with level loop and multi-level loop carpet types, the first and second oppositely facing projections 34, 36 of the deformable hooks 30a may attach to adjacent carpet loops preventing the slip-resistant protective mat 10, 10a, 10b, 10c from migrating. In the context of a desk mat, the use of deformable hooks 30, 30a has been shown to be effective for use with a variety of carpet pile heights, as the deformable hooks 30, 30a attach to the carpet pile preventing migration.

As shown in FIGS. 2B, 2C, and 2D, the slip-resistant protective mat 10a, 10b, 10c may include one or more recessed portions 42, 42a, 42b formed in the lower surface 22a, 22b, 22c of the body layer 12a, 12b, 12c. The recessed portions 42, 42a, 42b may be sized to accommodate the slip-resistant pad 14, 14a, 14b. For example as shown in FIG. 2B, recessed portion 42 may be sized in width and thickness to accommodate the slip-resistant pad 14 including the adhesive 28, so that the lower surface 26 of the slip-resistant pad 14 is generally flush with the lower surface 22a of the body layer 12a. A gap 44 between the terminal edge 46 of the slip-resistant pad 14 and the interior wall 48 of the recessed portion 42 enables easier placement of the slip-resistant pad 14. As shown in FIG. 2C, the recessed portion 42a may be sized in width and thickness to accommodate the slip-resistant pad 14a, so that the lower surface 26a of the slip-resistant pad 14a is generally flush with the lower surface 22b of the body layer 12b without the use of adhesive 28. Similar to FIG. 2C, the slip-resistant pad 14b shown in FIG. 2D may be attached in a recessed portion 42b to the lower surface 22c of the body layer 12c using a manufacturing process without adhesive 28.

As shown in FIGS. 2B and 2C, the recessed portions 42, 42a may have a sufficient depth so as to allow the slip-resistant protective mat 10a, 10b to lie completely flat against an underlying surface, with the slip-resistant pad 14, 14a (including the deformable hooks 30) already attached to the slip-resistant protective mat 10a, 10b. For example, as shown in FIGS. 2A and 2B, the slip-resistant pad 14a, 14b (including the deformable hooks 30) may be completely contained within the recessed portion 42, 42a. As a result, when the slip-resistant protective mat 10a, 10b is placed against an underlying carpeted surface, the carpet fibers enter the recessed portion 42, 42a and attach to the deformable hooks 30. When the slip-resistant protective mat 10a, 10b is placed against an underlying hard surface 16, the slip-resistant pad 14, 14a does not cause an undesirable raised region where the slip-resistant pad 14, 14a is located. While not shown, alternatively, the deformable hooks 30, 30a may be only partially contained within the recessed portion 42, 42a, with the deformable hooks 30, 30a being deformed when placed against the underlying hard surface 16. Having a recessed portion 42, 42a may also allow the body layer 12a, 12b to be thicker (with thicknesses T1a and T1b shown in FIGS. 2B and 2C respectively), and/or the slip-resistant pads 14, 14a to be thicker (with thickness T2a being shown in FIG. 2B). As previously discussed with respect to FIG. 1, the slip-resistant protective mat 10, 10a, 10b, 10c, 10d, 10e, 10e, 10f, 10g may include both slip-resistant pads 14, 14a, 14b with deformable hooks as shown in FIGS. 2A-E and a slip-resistant pad 14c as shown in FIG. 2E (possibly containing recessed portions 42, 42a) so as to allow the slip-resistant protective mat 10a, 10b to lie flat regardless of the underlying surface.

As shown in FIGS. 2C-2E, the slip-resistant pad 14a, 14b may be directly attached to the body layer 12b, 12c, 12d using a manufacturing process without the use of an adhesive 28. For example, as shown in FIG. 2C, the upper surface 24a of the slip-resistant pad 14a may be laminated to the body layer 12b using the recessed portion 42a. Persons skilled in the art would appreciate that a manufacturing process may be used in combination with the adhesive 28. As shown in FIG. 2E, the slip-resistant pad 14 may be integrally formed as a unitary piece with the body layer 12 during the manufacturing of the body layer 12, 12a, 12b ,12c.

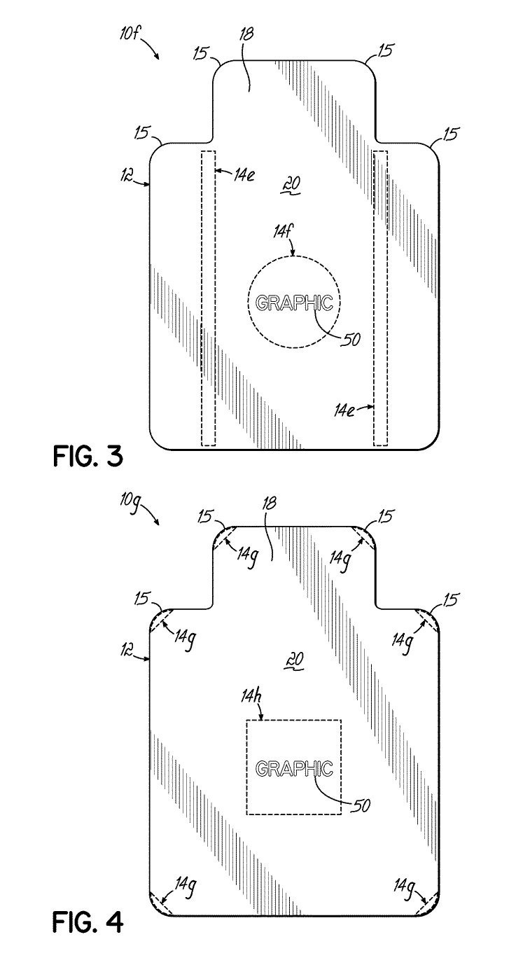

As shown in top schematic view of FIG. 1 and the cross-sectional views of FIGS. 2A-2F, the slip-resistant pads 14, 14a, 14b, 14c are circular in shape and may have a diameter of between about 1.5 inches to about 2 inches. In the slip-resistant protective mat 10c shown in FIG. 2D, the slip-resistant pad 14b may include a plurality of individual pad portions 37 that collectively form the slip-resistant pad 14b. Persons skilled in the art would appreciate that the slip-resistant pad 14, 14a, 14b, 14c, 14d, 14e, 14f, 14g, 14h may be any polygonal shape, such as a rectangular strip (as shown in FIG. 3) or a shape that conforms to the corner 15 of the body layer 12 (as shown in FIG. 4). As shown in FIG. 4, the slip-resistant pad 14g conforms to the shape of the corner 15, with each slip-resistant pad 14g including a curvilinear portion and an a linear portion.

FIGS. 3 and 4 each show that at least one of the plurality of slip-resistant pads 14f, 14h may have an increased size and be positioned at or near the center of the slip-resistant protective mat 10f, 10g. The upper surface (not shown) of slip-resistant pads 14f and 14h may optionally include a graphic 50 that is viewable through the body layer 12. For example, slip-resistant pads 14f, 14h may include a graphic 50 such as a company name, trademark, team logo, or another suitable graphic.

FIGS. 2F, 5 and 6 show various exemplary embodiments of the slip-resistant protective mat 10e, 10h that may be configured to reduce slippage with an underlying hard surface 16 (shown in FIG. 6). As shown in FIG. 2F, the lower surface 26c of the slip-resistant pad 14c may include a high-polished, smooth finish. This highly polished smooth finish may be instead of or in addition to the deformable hooks 30 of FIGS. 2A-2E. For example, as shown in FIG. 2F, the upper surface 24c and the lower surface 26c of the slip-resistant pad 14c may have a transparent and high-polished, smooth finish that obtained using a chromed rolling process as discussed below in relation to the slip-resistant layer 52 of FIGS. 5 and 6.

The slip-resistant pad 14c may be formed substantially from a second polyvinyl chloride material, as will discussed below with respect to the slip-resistant layer 52 of FIGS. 5 and 6. The slip-resistant pad 14d may have a static coefficient of friction greater than or about equal to 0.7μ, as measured using ASTM D1894-14, and a Shore hardness of between about 55 A to about 70 A configured to obtain maximum surface contact and to reduce slippage with an underlying hard surface 16. The Shore A Hardness Scale generally measures the hardness of flexible mold rubbers and semi-rigid plastics. The slip-resistant pad 14d may be attached to the lower surface 22 of the body layer 12 using adhesive 28 in a similar manner to the slip-resistant pad 14 described above in connection with FIG. 2A. Persons skilled in the art would appreciate that the slip-resistant pad 14d may be attached to the body layer 12 in the manners shown in FIGS. 2B, 2C, and 2D as well.

As shown in FIGS. 5 and 6, the slip-resistant protective mat 10h includes a body layer 12 and a slip-resistant layer 52. As shown in FIG. 6, the body layer 12 may extend coextensively with the slip-resistant layer 52. The body layer 12 is similar in structure and function to that of FIGS. 1-4 and has an upper surface 20 that opposes a lower surface 22. The slip-resistant layer 52 has an upper surface 54 that opposes a lower surface 56. At least the lower surface 56 of the slip-resistant layer 52 has a high-polished, smooth finish configured for maximum surface contact to reduce slippage with the underlying hard surface 16. The slip-resistant layer 52 may have a thickness T3 (shown in FIG. 6) of between about 0.008 inches to about 0.010 inches. The thicknesses of T1, T1a, T2, and T3 shown in the various embodiments are not drawn to scale.

According to one exemplary embodiment, the body layer 12 may be formed substantially from a first polyvinyl chloride material, while the slip-resistant layer 52 may be formed substantially from a second polyvinyl chloride material. As used herein, “formed substantially from” means that the first and second polyvinyl chloride materials may include additives such as plasticizers and the like. For example, the first polyvinyl chloride material may include about 45-80% polyvinyl chloride, about 0-40% inert filler(s), about 3-10% heat stabilizer(s), about 0-60% plasticizer(s), and about 0-5% colorant(s). The second polyvinyl polymeric material may include about 40-80% polyvinyl chloride, about 0-40% inert filler(s), about 3-10% heat stabilizer(s), about 0-40% plasticizer(s), about 0-5% colorant(s), about 0-4% antimony trioxide, and about 0-15% additional functional additive(s). In other embodiments, the body layer may be formed from a polycarbonate, a thermoplastic elastomer (sometimes referred to as a thermoplastic rubber), or any other suitable material.

The slip-resistant layer 52 has a Shore hardness of between about 55 A to about 70 A configured to obtain maximum surface contact and to reduce slippage with the underlying hard surface 16. As a result, the body layer 12 is generally “harder” than the slip-resistant layer 52 or the slip-resistant pad 14d to provide a rigid surface. Since the slip-resistant layer 52 and the slip-resistant pad 14d are “softer” than the body layer 12, the lower surface 56 of the slip-resistant layer 52 and the slip-resistant pad 14d both provide a high coefficient of static friction resisting movement of the slip-resistant protective mat 10g on a variety of underlying surfaces, such as underlying hard surface 16. For example, the coefficient of static friction between the lower surface 56 of the slip-resistant layer 52 and the underlying hard surface 16 may be about 0.7μ, as measured using ASTM D1894-14. The slip-resistant layer 52 may be made using a variety of manufacturing processes known to a person skilled in the art. One such manufacturing process is an extrusion-calendaring process. The upper and lower surfaces 54, 56 of slip-resistant layer 52 may have a transparent and high-polished, smooth finish obtained using a chromed rolling process. This transparent finish is preferred by users who desire that the slip-resistant protective mat 10g is transparent.

A method of manufacturing a slip-resistant protective mat 10g may include obtaining the body layer 12, 12a, 12b, 12c, 12d and the slip-resistant layer 52. In one exemplary embodiment, the body layer 12, 12a, 12b, 12c, 12d is formed substantially from a first polyvinyl chloride material using an extrusion-calendaring process. The slip-resistant layer 52 may be formed substantially from a second polyvinyl chloride material using a similar extrusion-calendaring process. At least the lower surface 56 of the slip-resistant layer 52 is chromed rolled yielding a highly polished, smooth finish configured for maximum surface contact to reduce slippage with the underlying hard surface 16.

The method may further include laminating the lower surface 22, 22a, 22b, 22c of the body layer 12, 12a, 12b, 12c to the upper surface 54 of the slip-resistant layer 52 to form the slip-resistant protective mat 10h (as shown by arrow 58 of FIG. 6). In one exemplary embodiment, the body layer 12, 12a, 12b, 12c, 12d is introduced to the slip-resistant layer 52 through a set of nip rollers at an average roll temperature of about 350 degrees Fahrenheit. This lamination is improved because the body layer 12, 12a, 12b, 12c, 12d and the slip-resistant layer 52 are at least formed substantially from the respective first and second polyvinyl chloride materials. This “material matching” between the lower surface 22, 22a, 22b of the body layer 12, 12a, 12b, 12c, 12d and the upper surface 54 of the slip-resistant layer 52 results in an improved lamination because the homogenous base composition of the two materials provides a permanent bond between the first and second polyvinyl chloride materials.

Lamination is superior as compared to mechanical spray applications or roller transfer system. First, lamination provides for a more permanent bond, as opposed to a coating applied using a mechanical spray or roller transfer system application. This is because lamination is a highly controlled process that utilizes heat and pressure to bond both layers together with reduced risk of uneven application of the plurality of slip-resistant pads 14, 14a, 14b, 14c, 14d, 14e, 14f, 14g or the slip-resistant layer 52 to the body layer 12, 12a, 12b, 12c. This lamination is further improved due to the material matching as described above. Secondly, coatings generally have a shorter usable lifespan as opposed to laminated layers because coatings are not applied with the same heat and pressure as compared to laminated layers. Third, lamination eliminates the possibility of residue from the coating negatively affecting the appearance of the underlying surface. Fourth, lamination can produce a visually transparent bonding between the body layer 12, 12a, 12b, 12c and the slip-resistant layer 52. Coatings, especially those sprayed onto a protective mat, may result in a non-transparent mat, which is less desirable for users.

While this invention has been illustrated by the description of one or more embodiments thereof, and while the embodiments have been described in considerable detail, they are not intended to restrict or in any way limit the scope of the appended claims to such detail. The various features as described herein may be used in the described combinations or in any combination according to the needs of the user. Additional advantages and modifications will readily appear to those skilled in the art. The invention in its broader aspects is therefore not limited to the specific details, representative slip-resistant protective mat 10, 10a, 10b, 10c, 10d, 10e, 10f, 10g and method and illustrative examples shown and described. Accordingly, departures may be from such details without departing from the scope or spirit of the general inventive concept.

What is claimed is:

1. A slip-resistant protective mat configured to reduce slippage with an underlying surface, the slip-resistant protective mat comprising:
a body layer having opposing upper and lower surfaces, and
a plurality of slip-resistant pads having opposing upper and lower surfaces, the upper surface of each of the plurality of slip-resistant pads being attachable to the lower surface of the body layer, wherein the lower surface of each of the plurality of slip-resistant pads includes at least one of:
a plurality of deformable hooks of a hook-and-loop type connector configured to attach to an underlying carpeted surface, and
a high-polished, smooth finish with a Shore hardness of between about 55 A to about 70 A configured to obtain maximum surface contact and to reduce slippage with an underlying hard surface.

2. The slip-resistant protective mat of claim 1, wherein the plurality of slip-resistant pads are each integrally formed as a unitary piece with the body layer.

3. The slip-resistant protective mat of claim 1, wherein the lower surface of the body layer includes a plurality of recessed portions each sized to accommodate one of the plurality of slip-resistant pads.

4. The slip-resistant protective mat of claim 1, wherein each hook of the plurality of deformable hooks includes first and second oppositely facing projections configured to attach to an underlying carpeted surface to reduce slippage in first and second lateral directions.

5. The slip-resistant protective mat of claim 1, wherein the upper and lower surfaces of the plurality of slip-resistant pads have a transparent and high-polished, smooth finish obtained using a chromed rolling process.

6. The slip-resistant protective mat of claim 5,
wherein the plurality of slip-resistant pads each has a static coefficient of friction greater than or about equal to 0.7μ, as measured using ASTM D1894-14, and
wherein the body layer has a Shore hardness of between about 50 D to about 65 D.

7. The slip-resistant protective mat of claim 1, wherein the body layer has a thickness of between about 0.06 inches to about 0.20 inches, and the plurality of slip-resistant pads each has a thickness of between about 0.03 inches to about 0.04 inches.

8. The slip-resistant protective mat of claim 1, wherein the plurality of slip-resistant pads are attached to the lower surface of the body layer using an adhesive.

9. The slip-resistant protective mat of claim 1, wherein the plurality of slip-resistant pads are attached during the manufacture of the slip-resistant protective mat using a lamination process.

10. The slip-resistant protective mat of claim 1, wherein at least one of the plurality of slip-resistant pads is circular in shape and has a diameter of between about 1.5 inches to about 2 inches.

11. The slip-resistant protective mat of claim 1, wherein at least one of the plurality of slip-resistant pads is shaped as a rectangular strip that extends from an extension portion of the body layer to an opposite end of the slip-resistant protective mat.

12. The slip-resistant protective mat of claim 1, wherein at least one of the plurality of slip-resistant pads conforms to the shape of a corner of the body layer.

13. The slip-resistant protective mat of claim 1, wherein at least one of the plurality of slip-resistant pads has an increased size relative to a remainder of the slip-resistant pads and is positioned near the center of the slip-resistant protective mat.

14. The slip-resistant protective mat of claim 1, wherein at least one of the plurality of slip-resistant pads includes a graphic image on the upper surface of the at least one of the plurality of slip-resistant pads that is viewable through the body layer.

15. The slip-resistant protective mat of claim 1, wherein the upper surface of the body layer has a textured finish obtained during the manufacture of the slip-resistant protective mat using a textured rolling process.

16. The slip-resistant protective mat of claim 1, wherein the slip-resistant protective mat is one of: a desk mat, a place mat, a chair mat, and a floor mat.

17. The slip-resistant protective mat of claim 1, wherein the body layer is shaped to include an extension portion configured to be placed into a well area of a desk.

18. A slip-resistant protective mat configured to reduce slippage with an underlying hard surface, the slip-resistant protective mat comprising:
a body layer having opposing upper and lower surfaces, the body layer being formed substantially from a first polyvinyl chloride material; and
a slip-resistant layer having opposing upper and lower surfaces, the lower surface of the slip-resistant layer having a high-polished, smooth finish configured for maximum surface contact to reduce slippage with the underlying hard surface, the slip-resistant layer being formed substantially from a second polyvinyl chloride material,
wherein the slip-resistant layer has a Shore hardness of between about 55 A to about 70 A configured to obtain maximum surface contact and to reduce slippage with the underlying hard surface.

19. The slip-resistant protective mat of claim 18, wherein the slip-resistant protective mat is formed by laminating the lower surface of the body layer to the upper surface of the slip-resistant layer, the lamination being improved since the body layer and the slip-resistant layer are formed substantially from the respective first and second polyvinyl chloride materials.

20. The slip-resistant protective mat of claim 18, wherein the upper and lower surfaces of slip-resistant layer each have a transparent and high-polished, smooth finish obtained using a chromed rolling process.

21. The slip-resistant protective mat of claim 18, wherein the slip-resistant layer includes a plurality of discrete slip-resistant pads each having upper and lower surfaces, the upper surface of each of the slip-resistant pad being attachable to the lower surface of the body layer.

22. The slip-resistant protective mat of claim 18, wherein the body layer is coextensive with the slip-resistant layer.

23. The slip-resistant protective mat of claim 18, wherein the body layer has a thickness of between about 0.06 inches to about 0.20 inches, and the slip-resistant layer has a thickness of between about 0.008 inches to about 0.010 inches.

24. A method of manufacturing a slip-resistant protective mat, the method comprising:
obtaining a body layer having opposing upper and lower surfaces, the body layer being formed substantially from a first polyvinyl chloride material;
obtaining a slip-resistant layer having opposing upper and lower surfaces, the lower surface of the slip-resistant layer having a high-polished, smooth finish configured for maximum surface contact to reduce slippage with the underlying surface, the slip-resistant layer being formed substantially from a second polyvinyl chloride material; and
laminating the lower surface of the body layer to the upper surface of the slip-resistant layer to form the slip-resistant protective mat, the lamination being improved since the body layer and the slip-resistant layer are formed substantially from the respective first and second polyvinyl chloride materials.

25. The method of claim 24, wherein the slip-resistant layer includes a plurality of discrete slip-resistant pads having upper and lower surfaces, wherein the laminating step further includes:
laminating the upper surface of each of the slip-resistant pads to the lower surface of the body layer without the use of an adhesive.

26. The method of claim 25, wherein the laminating step occurs at a temperature of about 350 degrees Fahrenheit.
